(19) United States
(12) Patent Application Publication
(10) Pub. No.: US 2025/0259814 A1
(43) Pub. Date: Aug. 14, 2025

(54) Fuse device

(71) Applicant: MTA S.p.A., Codogno LO (IT)

(72) Inventors: Andrea ARBASINI, Lodi (LO) (IT); Jacopo LOCATELLI, Casalpusterlengo (LO) (IT); Roberto MAGNANI, Lodi (LO) (IT); Paolo VALCARENGHI, Cremona (CR) (IT); Marco ROSSI, Livraga (LO) (IT)

(21) Appl. No.: 18/856,462

(22) PCT Filed: Apr. 11, 2023
(86) PCT No.: PCT/IB2023/053675

§ 371 Date: Oct. 11, 2024

(30) Foreign Application Priority Data
Apr. 13, 2022 (IT) 102022000007319

(51) Int. Cl. H01H 85/175; H01H 85/153; H01H 85/20

(52) U.S. Cl. CPC H01H 85/175; H01H 85/153; H01H 85/2045

(57) ABSTRACT

A fuse device comprises a fuse element. A first enclosure encloses a first internal volume in which a middle portion of the fuse is located, while end portions of the fuse element project from base portions of the first enclosure. A first base portion is shaped for retaining extinguishing material within the first internal volume, and a second base portion has a fill opening for the introduction of extinguishing material. A second enclosure has a third base portion, with an assembly opening for the introduction of the side walls of the first enclosure in a second internal volume to the second enclosure, and a fourth base portion configured to occlude the fill opening of the second base portion.

### TECHNICAL FIELD

The present disclosure is developed in the field of fuses for the protection of electrical circuits. The disclosure is particularly directed towards high voltage automotive fuses.

### BACKGROUND ART

In the automotive sector, particularly for electric or hybrid powered transport, direct current fuses are known that are suitable for low voltage use, with nominal voltages of 12, 24 or 48 V, and high voltage use, with nominal voltages of 500, 1000 or 1500 V.

These include a metal fuse element, with two electrical terminals that allow them to be connected in series with an electrical circuit. The two terminals are connected to each other through a fuse portion of the fuse element. The fuse portion is configured to conduct electric currents in the circuit in which the fuse is inserted, until a maximum current is reached. Beyond the maximum current, localized resistors of the fuse portion, formed for example as section constrictions of the fuse portion, cause an overheating of the fuse element until it melts, interrupting the electrical connection between the terminals and keeping them isolated as long as the electrical voltage is maintained at the expected levels.

The melting event, depending on the intensity of the current that determines it, can occur in a substantially explosive way, with the risk of damaging components close to the fuse. An enclosure then encloses the fuse portion, with the double purpose of containing the burst and housing extinguishing material, for example particular types of sand. In this disclosure, the noun “fuse” or the term “fuse device” is used to refer to the assembly of fuse element, enclosure, and, if provided, extinguishing material or any other component stably mounted thereto.

In particular, a high-voltage fuse device as disclosed in KR 20130024244 is known in the state of the art. This document discloses a high voltage fuse device comprising several concentric, substantially cylindrical enclosures. In detail, the innermost enclosure consists of two half-shells, and has an open base for pouring extinguishing material, and a closed base on the bottom. The two half-shells are held together by an additional cylindrical enclosure with both bases open. After the assembly of these enclosures and the pouring of the extinguishing material, a third enclosure is employed, also formed by two half-shells, and with the bases closed to retain the extinguishing material. Finally, two straps are fitted to the ends of the third enclosure to hold the two half-shells together.

### PROBLEM OF THE PRIOR ART

The fuse device of KR 20130024244 comprises an enclosure consisting of a large number of components, which makes the construction and assembly of the device rather complex with consequent significant production costs.

### SUMMARY OF THE DISCLOSURE

In this context, the technical task underlying the present disclosure is to propose a fuse device that overcomes the drawbacks of the prior art mentioned above.

In particular, it is an object of the present disclosure to provide a fuse device comprising an enclosure that can be made with a small number of components that can be easily made, maintaining mechanical resistance properties that are comparable or better than the fuse device of KR 20130024244 and with more advantageous production costs.

Another object of the disclosure is to simplify the filling and containment of extinguishing material in the fuse device.

The technical task mentioned, and the objects stated are substantially achieved by a fuse device comprising the technical features set out in one or more of the appended claims.

This device solves the technical problem in that it comprises a first and a second enclosure that are easily achievable and mutually couplable. After the extinguishing material has been inserted into the first enclosure, it is inserted at least partly into the second enclosure. A base of the second enclosure occludes the opening of the first enclosure from which the extinguishing material is inserted.

### LIST OF FIGURES

Further features and advantages of the present disclosure will become more apparent from the disclosure of an exemplary, but not exclusive, and therefore non-limiting preferred embodiment of a fuse device, as illustrated in the appended drawings, wherein:

FIG. 1 is a perspective view of a first embodiment of a fuse device according to the present disclosure,

FIG. 2 is a perspective section view of the fuse device of FIG. 1,

FIG. 3 is a perspective view of a detail from FIGS. 1 and 2,

FIG. 4 is a perspective view of an embodiment of a fuse device according to the present disclosure,

FIG. 5 is a perspective section view of the fuse device of FIG. 4, and

FIG. 6 is a perspective view of a detail from FIGS. 4 and 5;

### DETAILED DESCRIPTION

With reference to the appended figures, 1 refers to a fuse device according to the present disclosure. The fuse device 1 comprises a fuse element 2 made of electrically conductive material. Said fuse element 2 comprises two end portions 20, in particular first and second end portions 20, spaced apart along a longitudinal direction X-X and electrically connected to a middle portion 21.

The end portions 20 are configured to be connected to electrical terminals of electrical circuits (not shown in the attached figures), to connect the fuse element 2 in series to the circuit. The middle portion 21 of the fuse element 2 is designed to melt when a current above a pre-set threshold flows therethrough, thus opening the electrical circuit. In this way it is possible to safeguard the circuits and any electronic devices connected to them.

The fuse device 1 comprises a first enclosure 3 adapted to contain extinguishing material (not shown in the attached figures). The extinguishing material is used to extinguish the electrical arc in case of melting of the middle portion 21. Said first enclosure 3 has a first base portion 30 and a second base portion 31, spaced apart along the longitudinal direction X-X. The end portions 20 of the fuse element 2 project from the base portions 30, 31 of the first enclosure 3. In more detail, the first end portion 20 projects from the first base portion 30 and the second end portion 20 projects from the second base portion 31.

The first base portion 30 comprises a front wall 320 with a first through opening 301. Specifically, the first end portion 20 of the fuse element 2 extends through the first through opening 301 to the outside of the first enclosure 3.

The first enclosure 3 also has one or more side walls 32 connecting the first 30 and the second 31 base portion. The first enclosure 3 preferably has a substantially tubular shape, with the first 30 and second 31 base portions at the ends of the tubular shape, and the one or more side walls identifying a side surface of the tubular shape. For example, the tubular shape may be substantially cylindrical, with a single side wall 32, as seen in the figures, or the tubular shape may be more irregular.

The first base portion 30, the second base portion 31 and the one or more side walls 32 enclose a first internal volume 33. The middle portion 21 of the fuse element 2 is located in the first internal volume 33. In addition, the extinguishing material is also located in the first internal volume 33.

The first base portion 30 is shaped to retain extinguishing material within the first internal volume 33, when the fuse element 2 engages the first through opening 301. In fact, the first through opening 301 is sized so as to be substantially occluded by the first end portion of the fuse element 2. Preferably, the front wall 320 of the first base portion 30 has no other openings besides the first through opening 301.

The second base portion 31 has a fill opening 310 for introducing extinguishing material into the first internal volume 33.

The fuse device 1 also comprises a second enclosure 4. The second enclosure 4 has a third base portion 40 and a fourth base portion 41 spaced along the longitudinal direction X-X. The end portions 20 of the fuse element 2 also project from the base portions 40, 41 of the second enclosure 4. In particular, the first end portion 20 projects from the third base portion 40 and the second end portion 20 projects from the fourth base portion 41.

Said second enclosure 4 furthermore has one or more side walls 42 connecting the third 40 and the fourth 41 base portion. The third base portion 40, the fourth base portion 41 and the one or more side walls 42 enclose a second internal volume 43. Said second internal volume 43 is adapted to receive the first enclosure 3 at least partially. Like the first enclosure 3, the second enclosure 4 also has a substantially tubular shape.

Specifically, the second enclosure 4 is configured to receive the first enclosure 3 therein at least partially. For this purpose, the third base portion 40 has an assembly opening 400 for introducing the one or more side walls 32 of the first enclosure 3 into the second internal volume 43. Preferably, the assembly opening 400 is delimited by an edge 420 of the one or more side walls 42 of the second enclosure 4.

In more detail, the one or more side walls 32 of the first enclosure 3 are positioned internally adjacent to the one or more side walls 42 of the second enclosure 4, and have substantially the same cross-sectional shape. In other words, the one or more side walls 32 of the first enclosure 3 is/are slidable in the longitudinal direction X-X along the one or more side walls 42 of the second enclosure 4. Once coupled, the first 3 and the second 4 enclosure are arranged substantially coaxially with respect to the longitudinal direction X-X.

The fourth base portion 41 comprises a front wall 421 with a second through opening 410. Specifically, the second end portion 20 of the fuse element 2 extends through the second through opening 410 to the outside of the second enclosure 4. In more detail, the first through opening 301 and the second through opening 410 are aligned along the longitudinal direction X-X.

In addition, the fourth base portion 41 is configured to occlude the fill opening 310 of the second base portion 31, when the fuse element 2 engages the second through opening 410. In fact, the second through opening 401 is sized so as to be substantially occluded by the second end portion of the fuse element 2. Preferably, the front wall 421 of the fourth base portion 41 has no other openings besides the second through opening 410.

In detail, once the first enclosure 3 is inserted at least partly into the second enclosure 4, the fourth base portion 41 and the first base portion 30 impede the escape of the extinguishing material from the first internal volume 33 of the first enclosure 3. It should be noted that the extinguishing material is poured into the first enclosure 3 before the latter is inserted into the second enclosure 4.

The first enclosure 3 together with the second enclosure 4 perform the function of a burst chamber of the fuse device 1, as they contain the explosion and melting of the middle portion 21 of the fuse element 2. Advantageously, the first 3 and the second 4 enclosure give the fuse device 1 mechanical strength properties. It should be noted that the first enclosure 3 and the second enclosure 4 are preferably made of insulating material such as glass, ceramic, porcelain or preferably polymeric material, in particular thermoplastic or thermosetting material.

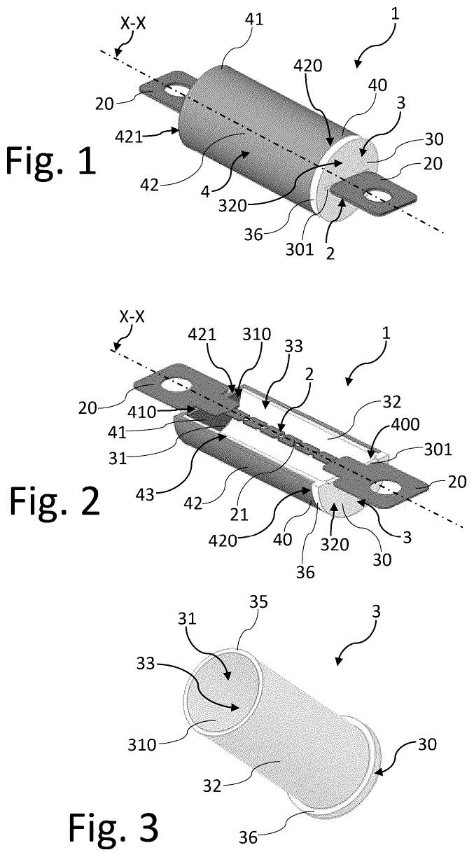

FIGS. 1, 2 and 3 show a first embodiment of the fuse device 1 that is the object of the present disclosure. In particular, in the first embodiment of the fuse device 1 the fill opening 310 is defined by an edge 35 of the one or more side walls 32 of the first enclosure 3. This fill opening 310 is configured both for pouring the extinguishing material into the first internal volume 33, and for allowing the passage of the first end portion 20 of the fuse element 2.

Further according to the first embodiment of the fuse device 1, with particular reference to FIG. 3, the first enclosure 3 may consist of a single piece.

Optionally, the first base portion 30 has a projection 36 configured to abut the third base portion 40 of the second enclosure 4, that is, the edge 420. In the illustrated embodiment, the projection 36 is shaped as an annular abutment around the first base portion 30.

In a preferred example of the first embodiment of the fuse device 1, the introduction of the first enclosure 3 into the second enclosure 4 takes place by sliding the one or more side walls 32 of the first enclosure 3 along the one or more side walls 42 of the second enclosure 4, as long as the projection 36 of the first base portion 30 is in abutment with the third base portion 40 and/or the second base portion 31 is in abutment with the fourth base portion 41.

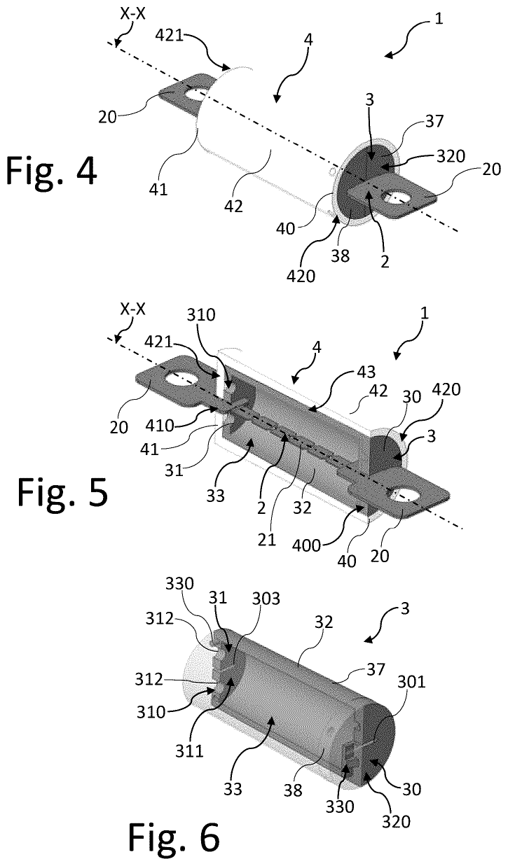

FIGS. 4, 5 and 6 show a second embodiment of the fuse device 1 that is the object of the present disclosure. According to the second embodiment of the fuse device 1, the first enclosure 3 comprises a first enclosure portion 37 and a second enclosure portion 38 in positive coupling with the first enclosure portion 37.

In detail, the first enclosure portion 37 and the second enclosure portion 38 have the same shape and are mutually assembled rotated by 180°. For example, in assembled condition the first and second enclosure portions 37, 38 may be symmetrical to each other with respect to a longitudinal axis of the fuse device 1. It should be noted that the first enclosure portion 37 and the second enclosure portion 38 can be made with the same mould, for example for injection moulding, thus optimizing the production of the first enclosure 3.

In order to assemble the first and second enclosure portions 37, 38, the first and second enclosures 37, 38 preferably comprise coupling elements 330 complementary to each other. In the preferred embodiment, in order to maintain the same shape of the first and second enclosure portions 37, 38, each of these has a coupling recess and a coupling projection shaped to engage the coupling recess of the opposite enclosure portion 37, 38.

Advantageously, the assembly of the first enclosure 3 by means of the coupling of the first enclosure portion 37 with the second enclosure portion 38 facilitates the coupling of the fuse element 2 with the first enclosure 3.

Further according to the second embodiment of the fuse device 1, the first enclosure portion 37 and the second housing portion 38 together delimit the first through opening 301 of the first base portion 30 and a third through opening 303 at the second base portion 31. Said third through opening 303 is arranged aligned with the first through opening 301 and the second through opening 410. Preferably the third through opening 303 and the second through opening 410 are arranged adjacent.

In detail, the second end portion 20 of the fuse element 2 extends through the third through opening 303, as well as the second through opening 410. In further detail, the first through opening 301 and the third through opening 303 are composed on the first base portion 30 and the second base portion 31, respectively, of the coupling between the first enclosure portion 37 and the second enclosure portion 38. In fact, both the first and third through openings 301, 303 are delimited in part by the first enclosure portion 37, and in part by the second enclosure portion 38.

Further according to the second embodiment of the fuse device 1, the second base portion 31 comprises a front wall 311 in which the fill opening 310 is formed, for example in the form of a circular hole 312. It should be noted that the third through opening 303 is also formed on the front wall 311. In a preferred example of the second embodiment of the fuse device 1, the fill opening 310 is created on the front wall 311 following the coupling between the first enclosure portion 37 and the second enclosure portion 38. Optionally, the second base portion 31 has multiple fill openings 310.

The assembly procedure of the fuse device 1 according to the second embodiment provides: the positioning of the fuse element 2 on the first enclosure portion 37, the coupling between the first 37 and the second enclosure portion 38, to lock the fuse element 2, the pouring of the extinguishing material into the first enclosure 3 through the fill opening 310, and finally the introduction of the first enclosure 3, at least in part, into the second enclosure 4, through the assembly opening 400.

1. A fuse device comprising:
a fuse element, comprising:
two end portions spaced apart in a longitudinal direction, and
a middle arranged between the end portions for electrically connecting the end portions, and configured to melt when a predetermined current flows therethrough;
a first enclosure, having:
a first base portion and a second base portion, spaced apart in the longitudinal direction, and
one or more side walls connecting the first base portion and the second base portion,
wherein the first base portion, the second base portion and the one or more side walls enclose a first internal volume, the middle portion of the fuse element being in the first internal volume, the end portions of the fuse element projecting out of the first base portion and the second base portion, respectively,
wherein the first base portion is shaped for retaining extinguishing material within the first internal volume, and the second base portion has a fill opening for introduction of extinguishing material into the first internal volume;
a second enclosure having:
a third base portion and a fourth base portion, spaced apart in the longitudinal direction, and
one or more side walls connecting the third base portion and the fourth base portion,
wherein the third base portion, the fourth base portion and the one or more side walls enclose a second internal volume,
wherein the third base portion has an assembly opening for introduction of the one or more side walls of the first enclosure into the second internal volume,
wherein the fourth base portion is configured to occlude the fill opening of the second base portion.

2. A fuse device as claimed in claim 1, wherein the first base portion comprises a first through opening, the corresponding end portion of the fuse element extending through the first through opening out of the first enclosure.

3. A fuse device as claimed in claim 1, wherein the fourth base portion comprises a second through opening, the corresponding end portion of the fuse element extending through the second through opening out of the second enclosure.

4. A fuse device as claimed in claim 1, wherein the one or more side walls of the first enclosure are located internally adjacent to the one or more side walls of the second enclosure.

5. A fuse device as claimed in claim 1, wherein the first enclosure and the second enclosure have a substantially tubular shape.

6. A fuse device as claimed in claim 1, in which the fill opening is delimited by an edge of the one or more side walls of the first enclosure, said fill opening being configured to allow the extinguishing material to be poured into the first internal volume, as well as the passage of the corresponding end portion of the fuse element.

7. A fuse device as claimed in claim 6, wherein the first base portion of the first enclosure has a projection configured to abut the third base portion of the second enclosure.

8. A fuse device as claimed in claim 2, wherein the first enclosure comprises a first enclosure portion and a second enclosure portion form fitting the first enclosure portion.

9. A fuse device as claimed in claim 8, wherein the first enclosure portion and the second enclosure portion together delimit the first through opening of the first base portion, and a third through opening formed in the second base portion, the corresponding end portion of the fuse element extending through said third through opening.

10. A fuse device as claimed in claim 9, wherein the second base portion comprises a front wall in which said fill opening is formed.
